(19) United States
(12) Patent Application Publication
(10) Pub. No.: US 2026/0220691 A1
(43) Pub. Date: Jul. 30, 2026

(54) PAPER-BASED ITEM MAPPING FOR ACCURATE DIGITAL LIST GENERATION USING GEN AI

(71) Applicant: Walmart Apollo, LLC, Bentonville, AR (US)

(72) Inventors: Santosh Anantharamaiah, Bangalore (IN); Ankit Singh Panwar, Uttar Pradesh (IN); Gurpinder Singh, Pleasanton, CA (US)

(21) Appl. No.: 19/041,847

(22) Filed: Jan. 30, 2025

(51) Int. Cl. G06Q 30/0601; G06V 30/148

(52) U.S. Cl. CPC G06Q 30/0633; G06Q 30/0623; G06V 30/153

(57) ABSTRACT

Examples provide a system for converting a paper-based list of items into a digital list with greater accuracy using generative artificial intelligence (Gen AI) and historical data associated with items frequently purchased with a given geographical region. A text-based list of items is extracted from an image of a paper-based list of items using optical character recognition (OCR), optical marker recognition (OMR), and/or fuzzy matching. The list can include specific items and/or generic descriptions of item types. A machine learning (ML) model analyzes historical data for item purchasing trends and user-specific transaction data to identify the most commonly purchased specific items for each generic item type. A single predicted specific item mapped to each generic item type is used to populate a digital list representing the paper-based list with greater accuracy without user intervention. User feedback enables re-training of the ML model to further improve accuracy of the item recognition.

### BACKGROUND

Customers currently do not have a quick and easy way to order items on demand and have them easily delivered into their home without navigating a merchant website or application. These services typically require a user to navigate to an order page or download the application and create an account before being able to search for desired items via the online platform and manually create an order. Some customers that are not very tech savvy frequently find it challenging to navigate this process independently. Other customers, lacking sufficient technical skills and/or access to online resources, may be completely unable to avail themselves of these online order services. Some systems enable customers to call a store and place an order verbally with a customer service representative. This can be a burdensome, time-consuming, expensive, and inefficient process for both customers as well as store personnel.

### SUMMARY

Some embodiments provide a method and system for creation of accurate digital lists from paper-based sources. An image of a paper-based list is generated by an image capture device. The image includes a generic item description for an item. The generic item description lacks at least one of a specific item name and a size option of the item. The generic item description is extracted from the image of the paper-based list. A generic item type is predicted based on the extracted generic item description. A plurality of specific item identifiers (IDs) associated with the generic item type is identified. The plurality of specific item IDs corresponds to a plurality of specific items available within a region. Historical item preference data associated with the generic item type is obtained. The historical item preference data includes region-specific item preferences within the region for the plurality of specific items. A most common item from the plurality of specific items is predicted using the historical item preference data and availability data of each specific item in the plurality of specific item. The specific item ID of the predicted most common item is mapped to the generic item description in the paper-based list. A digital list corresponding to the paper-based list in the image is created. The digital list comprising the mapped specific item ID, wherein an order is created using contents of the digital list.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for paper-based item mapping for generating accurate digital lists.

FIG. 2 is an exemplary block diagram illustrating a list manager component for paper-based item mapping to generate a digital list.

FIG. 3 is an exemplary diagram illustrating a pre-generated paper-based list.

FIG. 4 is an exemplary flow chart illustrating operation of the computing device to generate a digital list containing a predicted most common item generated based on a generic item description extracted from a paper-based list.

FIG. 5 is an exemplary flow chart illustrating operation of the computing device to generate a most common item prediction.

FIG. 6 is an exemplary flow chart illustrating operation of the computing device to automatically generate an order based on a paper-based list.

FIG. 7 is an exemplary flow chart illustrating operation of the computing device to enable feedback from a user associated with a generated digital list.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some embodiments, . . . ” For brevity and clarity of presentation, this implied leading clause is not repeated ad nauseum.

Many customers currently do not have a way to order items on demand and have them easily delivered into their home. The only mechanism to order items is through an online platform or through standard mail delivery. Some solutions permit customers to call a customer service representative to assist the user with placing an order if the customer is not tech savvy or has problems an e-commerce website or application to browse/search items and place the order. This can force customers to wait on hold for assistance, creating a bottle neck in the ordering process. Orders can also sometimes be placed in-person with store personnel or customer service. These options can be slow, tedious, and frustrating for customers that may have to wait in long lines while in-person or wait on hold when calling in for assistance by phone. Thus, current system for ordering can be overly complicated or slow and inefficient, resulting in lost orders, increased costs for merchants, and customer dissatisfaction.

Some embodiments recognize there is a need for a tool to bridge the technological skills gap for non-tech savvy customers to place orders without requiring technical skills to navigate a website or e-commerce application while avoiding the long wait and inconvenience associated with submitting orders manually by phone or by mail.

Referring to the figures, examples of the disclosure enables creation of accurate digital lists from paper-based sources. In some embodiments, an image capture device is provided for generating images of paper-based lists. A paper-based list can include a handwritten list, a pre-generated list, a printed list, or a hybrid list including some typed item names and some handwritten item names. The image data associated with images of paper-based lists are used to generate a digital list without user intervention or user selection of items from a digital list. The digital list is used to automatically create an order. This enables users that are not technologically savvy and/or users that do not have access to a computing device, to submit a paper-based list of items by simply uploading a digital image of the paper-based list. In this manner, an online order is created for the user without requiring the user to interact with the system increasing access to online ordering services to a wider range of users.

Some aspects of the invention enable users to automatically create an order through a reusable paper based approach where either they can select the items and the quantity from a pre-printed/predefined set of items provided in the reusable paper or write the desired items and quantity by hand, such as in print or cursive. In other embodiments, the user can take a picture of a desired product and send it to a list manager component for order creation. The orders are then automatically generated on behalf of the user via a machine learning (ML) model that predicts specific items which are most likely to fulfill the order without requiring the user to manually select each individual item personally. This enables even a non-tech savvy customer to place orders easily without calling and waiting for assistance from a store representative.

Still other aspects of the invention enables users to provide a paper list including generic items desired by the user. The customer can select items and quantity from a predefined set of items provided in a fillable paper list or a handwritten list of items and quantity of items. An image of the paper list is captured and uploaded to the generative artificial intelligence (Gen AI) list manager system. Optical character recognition is used to extract data from an image of the list. If the system is uncertain, the user is queried for feedback/confirmation of the list. The user can be shown an alternative digital list with one or more alternative items to replace any items in the original digital list created by the list manager which the user rejects. The system optimizes the ordering process by selecting items which are most commonly selected by this user or by users within a given region that are currently in-stock and available for order fulfillment which are most likely to match the generic items described in the paper list created by the user. This enables a quick, easy, user-friendly solution enabling order creation with minimal user interaction with the system enabling users with little or no technical skills to avail themselves of order services.

Other embodiments provide a trained ML model capable of analyzing image data and extracting specific item names and/or generic item descriptions which are used to automatically create a digital item list for ordering items from a merchant via an e-commerce website or application. The ML model is trained to recognize specific items and predict a specific item for any unrecognized generic items. The ML model automatically generates a digital list of items to be ordered without requiring the user to select a specific variety, quantity, size option, or brand. This simplifies the ordering process for less tech-savvy users and further provides more efficient and simplistic process for online order creation for all users.

The system, in other embodiments, enables a user to submit the paper-based list of items by taking a picture of a paper-based list via a phone or other application, scanning it with a scanner device to create a scanned image of the list, uploading one or more images of the list to the list manager via a website, providing the paper-based list to a store representative that uploads an image of the paper-based list, or reads a list of items from a paper-based list verbally via a chatbot, such as a GenAI chatbot. The uploaded paper-based list image is utilized to extract desired item data for use in automatically creating an order.

Other embodiments provide an ML model trained to predict the most common or popular specific item which corresponds to a generic item type and/or a generic item description. The ML model is able to predict a specific item which is most frequently purchases or most frequently preferred by customers at stores within a specific region, customers at one specific store location, and/or one-specific user based on region-specific historical item preferences data, store-specific historical item preferences data, and/or user-specific historical item preferences data. This enables the system to predict which brand, variety, size option, and/or quantity of an item a user is most likely to find preferable without the user specifying the name brand, variety, size option, and/or quantity in the paper-based list. This further simplifies the ordering process and enables the system to create an order for a user automatically without requiring any additional user input after receipt of the paper-based list image.

Other embodiments directly translates a paper-based list into a digital list having one specific item mapped to each item described in the paper list. This reduces network bandwidth usage which would otherwise be consumed during frequent back-and-forth requests for the user to manually select a brand, variety, size, and quantity of each and every item in the list. It further reduces processor usage and memory usage consumed in identifying multiple different options associated with each generic item in a list, displaying all the various products satisfying those options for each item in the list, prompting the user to select one of the many options available, confirming the selection, and then adding the item to a digital cart only after all questions have been asked and answered via a user interface (UI). Rather the system automatically creates an order with a one-to-one mapping of one predicted item mapped to each individual item or item type in the paper list. Thus, if the paper list includes three items, the system selects three specific items predicted to be preferred by the user and automatically places those three specific items into a digital list for order creation without additional user input. This reduces overall system resource usage, increases the speed with which a digital list can be created, and reduces user-time required for digital list generation.

In still other embodiments, the system automatically creates a digital list including both specific items identified from an image of a paper-based list as well as item predictions for generic item descriptions or item types included in the list which fail to map directly to a single specific item. This enables the system to dynamically create a partial digital list including specific items having a specific name, brand, variety, size, and quantity as well as placeholders for generic items which omit one or more parameters necessary to identify a specific item. The system then predicts a specific item name, brand, variety, size, and/or quantity as necessary to enable mapping of each generic item to a specific item in the digital list. This enables quick and efficient creation of a digital list with minimal user interaction with the system for an improved user experience via the UI and increased user interaction performance submitting an order with minimal or no computing skills.

The computing device operates in an unconventional manner by creating a complete order by predicting which specific item a user likely intended to order or likely prefers based on a generic item description extracted from the image of a paper-based list, such as a handwritten or pre-generated list without requiring additional user input or user selections of a specific item from multiple recommended items. In this manner, the computing device is used in an unconventional way, and allows digital list generation and order creation automatically based on a paper list while reducing system resource usage and minimizing user interaction with the system for a more user-friendly order creation experience for those with minimal technical skills, thereby improving the functioning of the underlying computing device.

In other embodiments, the system enables a user to view the automatically generated digital list prior to submission for creation of an e-commerce order. The user is given an opportunity to confirm the items in the digital list or reject one or more items. The user is provided with the ability to reject one or more items and receive a new predicted item to replace the rejected item. In this manner, the system reduces error rates associated with item predictions and enables user-provided feedback which is used to re-train and/or fine-tune the ML model for improved ML model digital list generation.

The system, in other embodiments, enables users to place an order through reusable paper based approach where either they can select the items and the quantity from a predefined set of items mentioned in a fillable paper list provided or write the required items by hand if the desired item is not included in the predefined list. The user takes a picture of the paper-based list when completed and uploads/inputs the image of the list through secure channels, such as via a phone application, an in-store kiosk, a scanner device, and/or with assistance from an in-store representative. In such cases, the paper-based orders can be placed by store representatives on behalf of the customers. With this even a non-tech savvy customer can place orders easily without waiting for assistance from someone else.

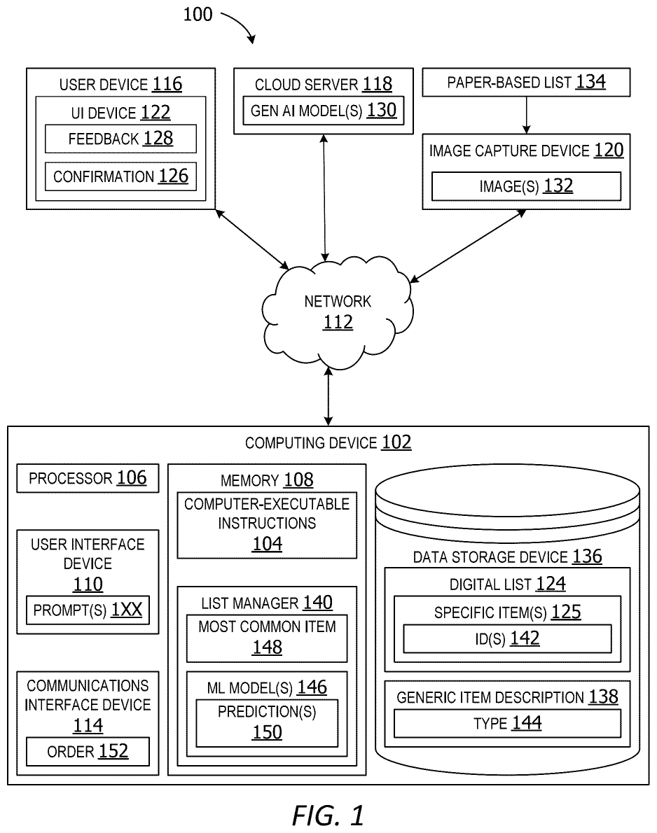

Referring again to FIG. 1, an exemplary block diagram illustrates a system 100 for paper-based item mapping for generating accurate digital lists. In the example of FIG. 1, the computing device 102 represents any device executing computer-executable instructions 104 (e.g., as application programs, operating system functionality, or both) to implement the operations and functionality associated with the computing device 102. The computing device 102, in some embodiments includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some embodiments, the computing device 102 has at least one processor 106 and a memory 108. The computing device 102, in other embodiments includes a user interface device 110.

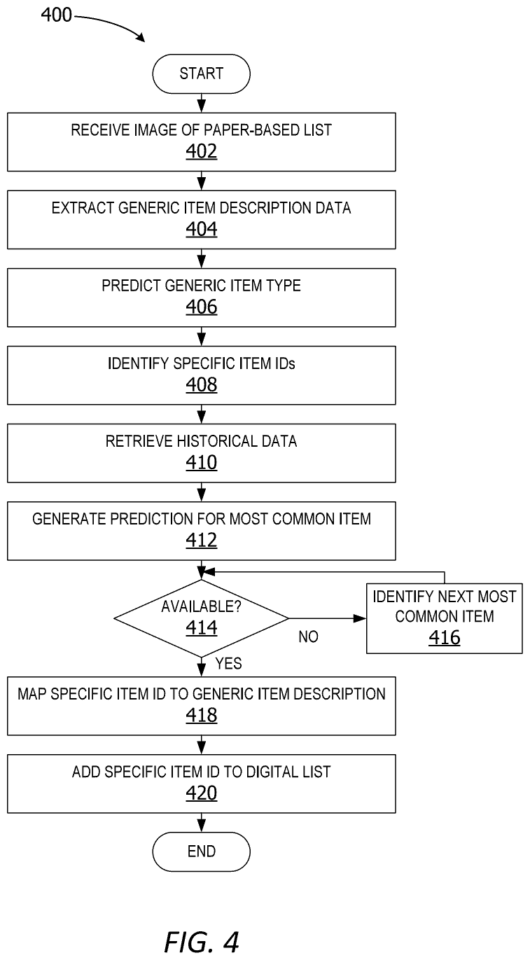

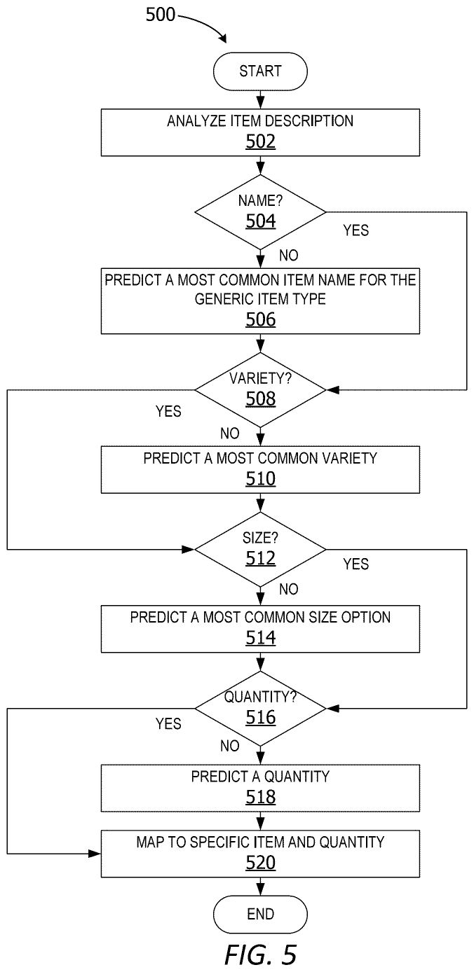

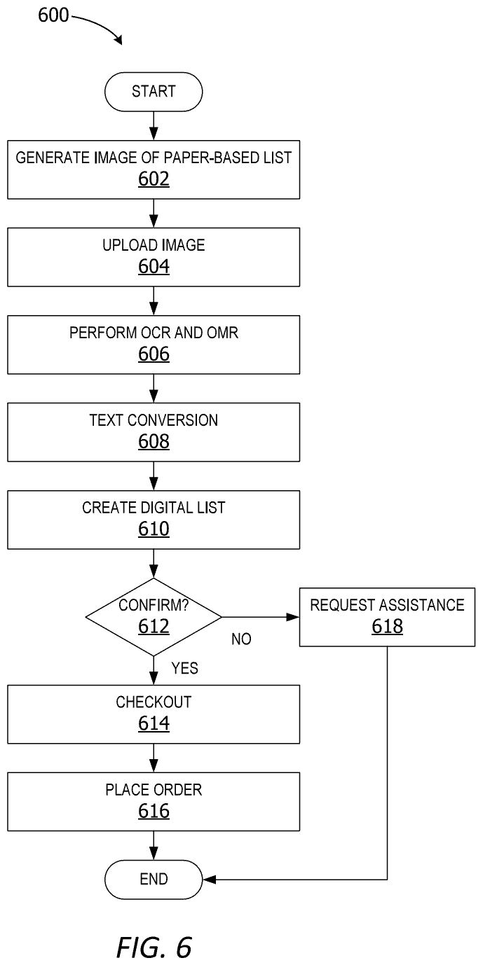

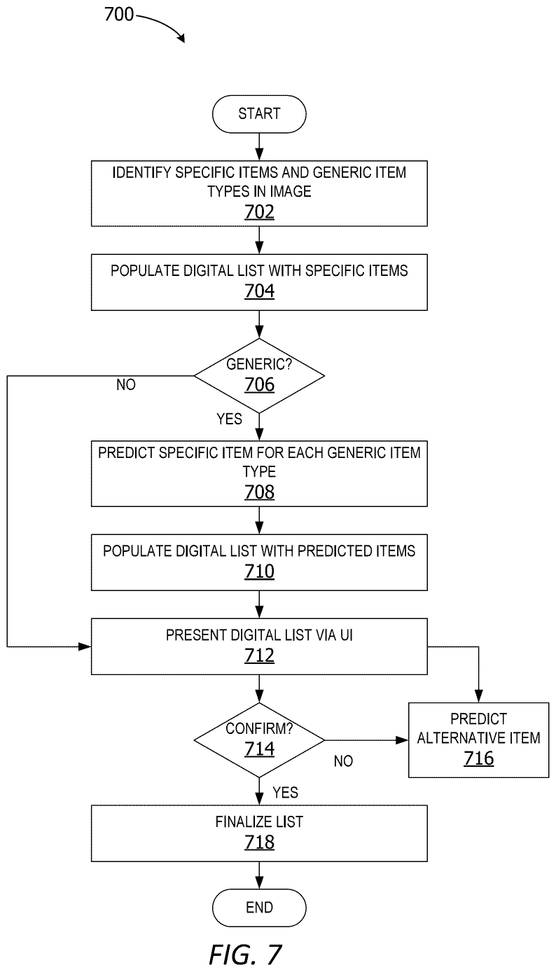

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, the processor 106 is programmed to execute instructions such as those illustrated in the figures (e.g., FIG. 4, FIG. 5, FIG. 6, and FIG. 7).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other embodiments, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other embodiments, the network 112 is a local or private LAN.

In some embodiments, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116, a cloud server 118, and/or an image capture device 120, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 1xx includes at least one processor and a memory. The user device 116 can also include a user interface (UI) device 122.

The UI device 122 is optionally utilized to present a digital list 124 including one or more specific item(s) 125 to a user for confirmation 126 and/or receive feedback 128 from the user regarding one or more of the items in the digital list 124. The UI device 122 is a UI for receiving input from the user and/or outputting data to a user, such as, but not limited to, the user interface device 110.

The cloud server 118 is a logical server providing services to the computing device 102 or other clients, such as, but not limited to, the user device 120. The cloud server 118 is hosted and/or delivered via the network 112. In some non-limiting examples, the cloud server 118 is associated with one or more physical servers in one or more data centers. In other embodiments, the cloud server 118 is associated with a distributed network of servers. In some embodiments, the cloud server 118 implements one or more ML models, such as, but not limited to, one or more Gen AI model(s) 130. The Gen AI model(s) 130 include any type of generative AI model, such as, but not limited to, a large language model (LLM).

The image capture device 120 includes one or more image capture devices for generating image(s) 132 of a paper-based list 134. An image capture device can include a digital camera for capturing still images and/or a camera for generating video. The image(s) 132 can include black-and-white images or color images. The image(s) 132 include one or more images of a paper list, such as the paper-based list 134.

In these embodiments, the image(s) 132 do not include images of users or other individuals within a retail facility or any other location. Any images having human users or other objects which are not of interest inadvertently included within the image(s) 132 are removed from the image(s) by cropping the images such that only images of the paper-based list 134 remain. Images of users or objects which are not of interest are deleted or otherwise discarded.

The system 100 can optionally include a data storage device 136 for storing data, such as, but not limited to a digital list 124 and/or generic item description 138 extracted from the image(s) 132 of the paper-based list 134. The digital list 124 includes a list of one or more specific item(s) and/or specific item identifiers (IDs) 142. A specific item ID is an identifier associated with a specific item. The ID can include a quick response (QR code), a universal product code (UPC), a radio frequency identifier (RFID), or any other item identifier.

A generic item description 138 includes digital data representing text describing an item extracted from the image(s) 132 of the paper-based list 134 by one or more ML model(s) 146 associated with a list manager 140. The generic item description 138 optionally is used to identify a generic item type 144. An item type is a generic name or class of items. For example, the term “apple” is a generic name or type of item which has many more specific varieties and size options available to choose from when purchased from a merchant. The word “apple” alone is a generic description or generic item type which cannot be mapped directly to a specific variety of apples. However, the more specific item description “bag of red delicious apples” or “five granny smith apples” contains an identification of a specific variety of apples and size option which can likely be mapped to one specific item for inclusion in the digital list. In this example, “red delicious” is the specific type of apples and a bag is the size option. Likewise, in the second description, “granny smith” is the variety and the number five indicates a desired quantity or number of instances of individual apples desired. The size option in the “granny smith” example indicates individual apples rather than bags or other pre-packaged options for purchasing apples.

The data storage device 136 can include one or more different types of data storage devices, such as, for example, one or more rotating disks drives, one or more solid state drives (SSDs), and/or any other type of data storage device. The data storage device 136 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other embodiments, the data storage device 136 includes a database.

The data storage device 136 in this example is included within the computing device 102, attached to the computing device, plugged into the computing device, or otherwise associated with the computing device 102. In other embodiments, the data storage device 136 includes a remote data storage accessed by the computing device via the network 112, such as a remote data storage device, a data storage in a remote data center, or a cloud storage.

The memory 108 in some embodiments stores one or more computer-executable components, such as the list manager 140. The list manager 140, when executed by the processor 106 of the computing device 102, obtains an image or image data uploaded by a user device 116 or the image capture device 120. The image(s) 132 can alternatively be scanned via a scanner device. The list manager 140 extracts the generic item description 138 from the image(s) 132 of the paper-based list 134 using optical character recognition (OCR) and/or optical mark recognition (OMR). Where a clear interpretation of the text or handwritten marking on the paper-based list cannot be determined, the one or more ML model(s) 146 applies fuzzy matching to identify a specific item and/or a generic item type where a variety and/or size option of an item is omitted in the paper-based list 134.

The list manager, in some embodiments, generates one or more prediction(s) 150 as to the generic item type 144 for one or more generic item descriptions identified in the paper-based list image(s) 132. The list manager 140 identifies a plurality of specific items associated with each generic item type. The list manager 140 generates a prediction as to which item in the plurality of specific items corresponding to a given generic item type is most commonly purchased or most commonly preferred within a given region. The predicted most common item 148 is mapped to the generic item description 138.

The term “most common” refers to an item predicted by the system to most likely be the specific item desired by the user based on the generic item description extracted from the paper-based list and historical data associated with purchased items, popular items, seasonal items, user-preferences, and other historical data associated with items commonly preferred or most frequently purchased.

The term “most common item” is not limited to an item that is purchased most commonly or most commonly selected. A most common item refers to an item predicted to be preferable or most commonly preferred by a specific user or by one or more users within a given region. An item can be predicted to be a most common item based on preferences data, such as historical purchase data identifying items purchased for a single user, for one or more customers at a specific store, all customers at a specific store, all customers at multiple stores within the same region, etc. The historical data can specify which brands are most commonly selected by one or more customers, which varieties are most popular among a group of one or more customers, which size options are most commonly purchased, etc.

The most common item may not be an item which is most abundant in inventory or an item which is over-stocked or most generic, but rather is based on which item is predicted to be most commonly purchased by one or more customers. In some cases, the most common item prediction is for an item that is sold most (highest sales) for the region. However, in other cases, the most common item may not be an item which is purchased most frequently or an item having the highest sales. It can be an item which is most popular for a given time of the year (season or month).

In some embodiments, the list manager makes predictions as to what the item most commonly preferred or most likely to be preferred based on a variety of dynamic data and historical data, such as weather, sales, market trends, seasonality, holidays, local events, user-preference, etc. For example, pumpkin spice scented air fresheners may be predicted to be the “most common” item during the fall even if the item does not have the highest sales overall because the variety is popular for the time of year/season.

In some embodiments, the most common item is predicted based on region-specific data and/or user-specific data, such as historical purchase data for a given region, historical purchase data for a given store, historical purchase data for a given user, etc. The historical data includes data associated with market trends, most purchased items, popular items at a given store, items frequently purchased by a given user, seasonal items which are typically purchased during a given season or within a given time-frame within a specific area or region. For example, snow shovels may be commonly purchased in northern regions during winter but not commonly purchased in more southern regions during the same time period.

The list manager generates the digital list, including one or more specific item(s) 125. The specific item(s) 125 include a specific item name, item ID(s) 142, a selected variety, size option, and/or quantity. The specific item(s) 125 include specific items mapped directly to the digital list based on specific item names and quantities provided in the paper-based list 134 as well as predicted most common items mapped to the digital list based on one or more generic item descriptions in the paper-based list. The digital list 124 is stored in the data storage device 136 and used to create an online order 152 which is submitted for order fulfillment. In some non-limiting embodiments, the order 152 is submitted to the cloud server 118 or other remote order fulfillment computing system via the network 112.

In some embodiments, the list manager 140 applies a hierarchy for prioritizing historical data. In this example, user-specific historical preferences data specifying previously purchased items, most frequently purchased items by this specific user, and user-provided preferences data is given the highest priority. If user-specific data is unavailable for a particular type of item, the system utilizes more generalized region-specific preferences data for most commonly purchases items/most popular items at one or more stores within a specific region. A region can include a neighborhood having a single store, a city having multiple stores, a county, a multi-city area, a portion of a state, an entire state, a country, or any other type of region.

For example, if a paper-based list includes a generic description for a pint of ice cream, the system checks for user-specific historical data associated with ice cream purchases. If the customer frequently purchases both chocolate ice cream and rocky road ice cream, the system determines which variety is purchased most frequently by the user. If chocolate is purchased seventy percent of the time and rocky road purchased twenty percent of the item while other flavors and varieties are purchased the other ten percent of the time, the system predicts that the most common item likely to be acceptable to the user is a pint of chocolate ice cream.

In another embodiment, if a paper-based list includes a generic description for hot chocolate, but the user-specific historical data has not data associated with hot chocolate or the image of the paper-based list is not linked to a user ID making historical data unavailable for this specific user, the system retrieves historical data for items purchased at one or more stores in a given region. If the historical data indicates that a brand “A” of instant hot chocolate with mini marshmallows is most commonly purchased by customers in this region, the system predicts the brand “A” of the instance hot chocolate with mini marshmallows is added to the digital list as the most commonly preferred specific item and therefore most likely to be acceptable to the customer.

In an example scenario, a paper list with three items, including a loaf of bread, a gallon of milk and butter is automatically translated into a digital list containing three specific items predictions made by the list manager, a specific bread item having a brand and variety predicted to be desirable to the ser, a specific milk item in a gallon size container having a brand and variety predicted to be desirable to the user, and a specific butter type item of a specific brand, variety and package size predicted to be desirable or preferred by the user based on user preferences, market trends, and popularity of various brands, varieties, and size options for items commonly purchased within a given region during a given predetermined time period.

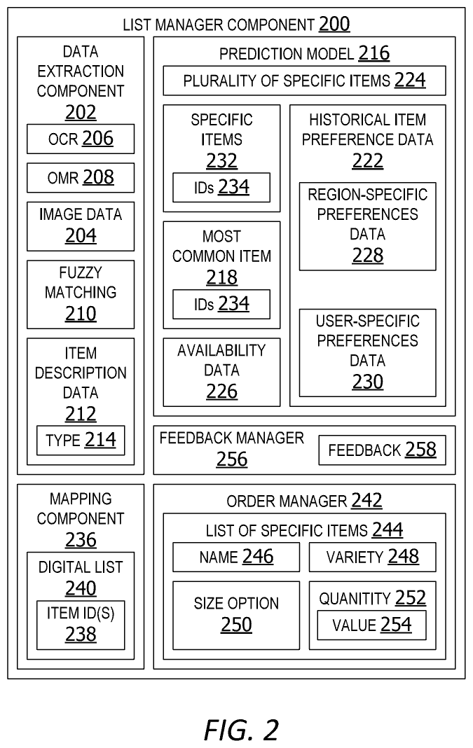

FIG. 2 is an exemplary block diagram illustrating a list manager component 200 for paper-based item mapping to generate a digital list. The list manager component 200 is a tool for converting an image of a paper-based list into a digital list automatically for use in creating an order while minimizing user-input required during creation of the order, such as, but not limited to, the list manager 140 in FIG. 1.

In some embodiments, the list manager component 200 includes a data extraction component 202. The data extraction component 202 analyzes image data 204 associated with an image using OCR 206, OMR 208, and/or fuzzy matching 210 to generate item description data 212 to identify a generic item type 214. The OCR and OMR are used to extract text-based information from the image data 204. The image data is data associated with an image of a paper-based list, such as, but not limited to, the image(s) 132 in FIG. 1. The item description data 212 is data extracted from the text, such as, but not limited to, the generic item description 138 in FIG. 1. The item description data can include a name or description of one or more items. The one or more items named and/or described in the item description data can include one or more specific items and/or one or more generic item types. A generic item type lacks at least one of a specific variety and/or a size option for the item.

In other embodiments, a prediction model predicts the generic item type 214 using the extracted generic item description data 212. The prediction model 216 includes one or more ML models, such as a Gen AI model for analyzing the item description data 212 and predicting a most common item 218 which is likely to acceptable to a user based on historical item preferences data 222 and/or item availability data 226 indicating availability of one or more of the items in the plurality of specific items 224 associated with the predicted generic item type 214.

The historical item preferences data 222, in some embodiments, includes data identifying the most popular items and/or specific varieties and size options of items which are most frequently selected by customers in a specific region. The historical item preferences data 222 can include region-specific data 228 for one or more stores in a given region and/or user-specific preferences data associated with previous purchases and item preferences associated with a specific user. User-specific preferences data 230 is data linked to a user ID or customer ID. The user-specific preferences data is used where a user ID or customer ID is provided with the image(s) of the paper-based list. If no user ID or customer ID is available, the more general region-specific preferences data 228 is utilized by the prediction model 216. The prediction model 216 identifies specific items 232 and/or specific item IDs 234 with the generic item type 214 for each unrecognized item or generic item described in the paper-based list.

In some embodiments, a mapping component 236 maps item ID(s) 238 for each most common item to the digital list 240. The ID(s) 238 include one or more item identifiers, such as, but not limited to, the ID(s) 142 in FIG. 1. The digital list 240 includes an item ID for each item specifically identified in the paper-based list as well as a predicted item ID for each most common item 218 mapped to a generic item type in the paper-based list.

An order manager 242, in other embodiments, generates an order including a list of specific items 244. Each item in the list of specific items added to the digital list 240 includes a specific item name 246, variety 248, size option 250, and quantity 252 value 254. A name is an identification of a name of an item, such as apples, grape jelly, salt, paper towels, water, butter, etc. A variety is a specific variety of a more generic type of item. For example, salt can include table salt, sea salt, salt substitutes, etc. Paper towel varieties can include different name brands of paper towels. Grape jelly can include organic grape jelly, sugar-free grape jelly, regular grape jelly, etc.

A size option 250 refers to the size options for purchasing an item. For example, grape jelly can be available if different sized jars containing different amounts of jelly in each jar. Paper towels can be purchased in packages containing a single roll or paper towels, two rolls, four rolls, six rolls, ten rolls, twelve rolls, etc. Potato chips can be purchased in different sized bags as well as in variety packs containing multiple different brands and types of chips in a single package.

Quantity 252 refers to the number of instances of each item. For example, a user can purchase a single package of paper towels containing two rolls (double roll package) of paper towels or purchase four instances of the double roll packages of paper towels. Likewise, a user can purchase a single variety pack of potato chips or purchase three instances of the variety packs of potato chips. The value 254 of the quantity 252 specifies the number of instances of each item is desired.

A feedback manager 256 in some embodiments, prompts a user to provide feedback 258 via a UI, such as, but not limited to, the user interface device 110 and/or the UI device 122 in FIG. 1. The feedback 258 can include data associated with items in the digital list 240 rejected by the user and/or feedback provided by the user directly via a text field or spoken feedback provided via a conversation with a chatbot.

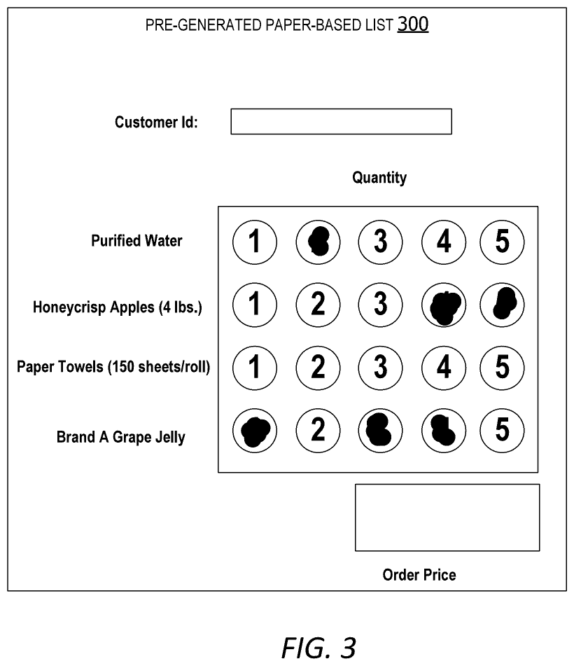

Turning now to FIG. 3, an exemplary diagram illustrating a pre-generated paper-based list 300 is shown. The pre-generated paper-based list 300 is a paper-based list, such as, but not limited to, the paper-based list 134 in FIG. 1. In this non-limiting example, the paper-based list 300 includes a customer ID field for a user to enter a customer ID number, such as an account number, rewards program number, phone number, etc. The pre-generated paper-based list 300 includes a list of specific items and item quantity options. The user fills in a bubble on the form associated with each desired item to indicate a quantity (number of instances) of each item is desired. If no bubble is filled in, the item is ignored and not included in the digital list. However, the embodiments are not limited to a pre-generated paper-bases list. The paper-based list, in other embodiments, can include a handwritten list of items and/or item descriptions. In other embodiments, the paper-based list is a hybrid list containing some pre-generated items and some handwritten items added to the list.

In this example, the user fills in bubbles on a form to indicate desired items and quantities of items. However, the embodiments are not limited to pre-generated paper-based lists with a fill-in the bubble format. In other embodiments, a pre-generated paper-based list can include check boxes, fill-in-the blank text fields enabling a user to write in item names or descriptions by hand, or any other type of paper-based list. In still other embodiments, a user can select images of items via a UI. In such cases, a digital list is created based on the images of items selected by the user. In still other embodiments, the user reads a list out loud or uses natural language speech to input item names or generic item descriptions into the system. The system creates the digital list using the input item names and/or generic descriptions spoken by the user. In these examples, a LLM and/or natural language processing (NLP) is used to extract item data from the input list.

FIG. 4 is an exemplary flow chart illustrating operation of the computing device to generate a digital list containing a predicted most common item generated based on a generic item description extracted from a paper-based list. The process 400 shown in FIG. 4 is performed by a list manager component, executing on a computing device, such as the computing device 102 or the user device 116 in FIG. 1.

The process begins by receiving an image of a paper-based list at 402. The list is a pre-generated hardcopy list or a handwritten list on a piece of paper, such as, but not limited to, the paper-based list 134 in FIG. 1. Generic item description data is extracted from the image at 404. The data is extracted using OCR and/or OMR. A generic item type is predicted based on the extracted data at 406. Specific item IDs associated with the item type are identified at 408. For example, if the item type is apples, the specific item IDs can include item IDs for Honey Crisp apples, Fuji apples, Red Delicious apples, Pink Ladies, Granny Smith apples, as well as any other apple varieties. Historical data is retrieved at 410. The historical data includes historical item preferences data, such as, but not limited to, the historical item preferences data 222 in FIG. 2. The item manager generates a prediction for a most common item corresponding to the generic item type at 412. The most common item prediction can differ for different stores in different regions as well as for different users. A determination is made whether the item is available at 414. If not, a next most common item is identified that is available at 416. The specific item ID for the predicted most common item is mapped to the generic item description at 418. The specific item ID is added to the digital list at 420. The digital list is a list of specific items for use in creating an order, such as, but not limited to, the digital list 124 in FIG. 1 and/or the digital list 240 in FIG. 2. The process terminates thereafter.

While the operations illustrated in FIG. 4 are performed by a computing device, aspects of the disclosure contemplate performance of the operations by other entities. In a non-limiting example, a cloud service performs one or more of the operations. In another embodiment, one or more computer-readable storage media storing computer-readable instructions may execute to cause at least one processor to implement the operations illustrated in FIG. 4.

FIG. 5 is an exemplary flow chart illustrating operation of the computing device to generate a most common item prediction. The process 500 shown in FIG. 5 is performed by a list manager component, executing on a computing device, such as the computing device 102 or the user device 116 in FIG. 1.

The process begins by analyzing an item description at 502. The item description is extracted from a paper-based list, such as, but not limited to, the generic item description 138 extracted from the image(s) 132 in FIG. 1 and/or the item description data 212 in FIG. 2. A determination is made whether the item description includes an item name at 504. If not, a most common item name for a generic item type is predicted at 506. For example, if the paper list includes the word “fruit,” the system predicts the fruit that is most commonly purchased or preferred by the user or other users in the region. If user-data indicates this user purchases bananas more frequently than other types of fruit, the list manager predicts that “bananas” is the name of the generic type “fruit” most likely to be preferred by the user. Likewise, if the paper list includes the word “meat” and the user-specific historical data indicates the user frequently purchases ground beef and only rarely purchases sausage or chicken, the system can predict the item name most likely intended is “hamburger meat” or “ground beef” based on the user's previous meat purchases. The prediction is made based on a predicted item type, such as, but not limited to, the generic item type 144 in FIG. 1. A determination is made whether a variety of the item is identified at 508. If not, a most common variety is predicted at 510. The prediction is made based on historical item preferences data for a region, store, and/or a specific user. A determination is made whether a size is specified in the item description at 512. If not, a most common size option is predicted at 514. A determination is made whether a quantity is specified in the item description extracted from the paper-based list at 516. If not, a quantity is predicted at 518. The quantity is predicted based on historical quantities of this specific item in the past. For example, if a user typically purchases one pound of ground been at a time, the system predicts the quantity should be one pound of ground beef. A specific item and quantity predicted by the list manager is mapped to the generic item description at 520. The process terminates thereafter.

In this example, a quantity is predicted where a quantity is missing from the paper-based list. However, in other embodiments, a standard default quantity value is used. In some embodiments, the default value is a single instance of the item. In other embodiments, a user-selected default quantity is applied.

While the operations illustrated in FIG. 5 are performed by a computing device, aspects of the disclosure contemplate performance of the operations by other entities. In a non-limiting example, a cloud service performs one or more of the operations. In another embodiment, one or more computer-readable storage media storing computer-readable instructions may execute to cause at least one processor to implement the operations illustrated in FIG. 5.

FIG. 6 is an exemplary flow chart illustrating operation of the computing device to automatically generate an order based on a paper-based list. The process 600 shown in FIG. 6 is performed by a list manager component, executing on a computing device, such as the computing device 102 or the user device 116 in FIG. 1.

The process begins by generating an image of a paper-based list at 602. The image is generated by an image capture device, such as, but not limited to, the image capture device 120 in FIG. 1. The image is uploaded at 604. The image is uploaded to a cloud storage or a data storage device in some embodiments, such as, but not limited to, the data storage device 136 in FIG. 1. OCR and/or OMR is performed at 606. The system performs text conversion at 608. The text is converted from the image data to digital text. A digital list is created at 610. A determination is made whether the digital list is confirmed at 612. If not, assistance is requested at 618. The assistance can be requested in the form of an alert dispatched to a store representative if the user is uploading the image of the paper-based list within a brick-and-mortar store. The assistance can be provided via a chatbot or instant messaging with a representative where in-person assistance is unavailable.

Returning to 612, if the list is confirmed, checkout is completed at 614. The checkout is completed via a UI, such as, but not limited to, the user interface device 110 in FIG. 1 and/or the UI device 122 in FIG. 1. The order corresponding to the digital list is placed at 616. The process terminates thereafter.

While the operations illustrated in FIG. 6 are performed by a computing device, aspects of the disclosure contemplate performance of the operations by other entities. In a non-limiting example, a cloud service performs one or more of the operations. In another embodiment, one or more computer-readable storage media storing computer-readable instructions may execute to cause at least one processor to implement the operations illustrated in FIG. 6.

FIG. 7 is an exemplary flow chart illustrating operation of the computing device to enable feedback from a user associated with a generated digital list. The process 700 shown in FIG. 7 is performed by a list manager component, executing on a computing device, such as the computing device 102 or the user device 116 in FIG. 1.

The process begins by identifying specific items and generic item types in image at 702. The specific items and generic item types are extracted from the image of a paper-based list containing text. The text can be printed text or handwritten text, as well as include markings such as check marks, bubble fill, circled items, etc. A digital list is populated with specific items extracted from the image at 704. A determination is made whether any generic items remain at 706. If yes, the system predicts one specific item for each generic item type at 708. The digital list is populated with the predicted items at 710. The digital list is presented to a user for review via a UI at 712. A determination is made whether user confirmation is received at 714. If not, an alternative item is predicted at 716. The system iteratively executes operations 712 through 716 until user confirmation is received. The digital list is finalized at 718. The process terminates thereafter.

While the operations illustrated in FIG. 7 are performed by a computing device, aspects of the disclosure contemplate performance of the operations by other entities. In a non-limiting example, a cloud service performs one or more of the operations. In another embodiment, one or more computer-readable storage media storing computer-readable instructions may execute to cause at least one processor to implement the operations illustrated in FIG. 7.

### Additional Examples

In some embodiments, the system is an artificial intelligence system for implementing paper-based solutions to make order placement easier for customers. The system captures and uploads an image of a paper list to the Generative AI system. The system uses fuzzy matching to match items in the handwritten or printed/typed paper list (pre-defined list) with items in inventory. The system uses OCR to read the list for fuzzy matching of handwritten items with items in inventory. The system displays items for verification and confirmation via a UI. The system enables the user to correct or edit the system generated list and/or quantities of each item via the UI. The system incorporates a feedback loop using user provided feedback to improve item recognition/OCR results and fuzzy matching of handwritten items in inventory. The system makes placement of orders via e-commerce.

In an example scenario, if a user submits a paper-based list of items including the word “milk” and “grape jelly,” the system automatically captures an image of the list via an image capture device associated with a hand-held user computing device, an image capture device mounted near an order area or an image capture device mounted on a robotic device. The image is analyzed to extract text data, including the words “milk” and “grape jelly.” If the user provides an ID number, such as an account number, profile number, customer number or other ID linked to purchase history, the system checks previous purchases to identify which brand, size, and variety of milk the user typically purchases. The system checks the user-specific historical data to determine which brand and size grape jelly the user purchases most frequently (most common). If available, the user-specific historical data is used to predict which specific items and quantities should be mapped to the two items in this paper-based list. If the user-specific historical data is available and indicates the user generally purchases either a gallon of whole milk in the store brand or a half gallon of the store brand whole milk, the system identifies which size is purchased the most frequently. In this example, if the gallon size is purchased most frequently by the customer and the gallon size is available, the gallon size of the store brand whole milk is mapped to the generic time description “milk.” However, if the user-specific historical data does not include any previous purchase history associated with grape jelly, the system retrieves region-specific historical data associated with grape jelly purchases by customers from one or more stores in the region. If the region-specific historical data indicates customers at this store or a few stores in the local area typically purchase a brand “X” grape jelly in a twelve ounce size jar, the system maps the twelve ounce jar of brand “X” grape jelly to the generic “grape jelly” item description. In this example, the user's most commonly purchased specific milk item (one gallon store brand whole milk) is added to the digital list with the most common regional twelve ounce jar of brand “X” grape jelly is also added to the digital list. In this manner, the system utilizes a hierarchy of prioritization of historical data to predict which specific items should be added to the digital list where the user fails to provide values for all parameters of each desired item, such as brand, variety, size option, and quantity.

In other embodiments, the system generates a predicted most common item based on regional preferences. For example, a regional preference in one area might include a preference for a Brand “A” of soft drinks while a regional preference in another different second area includes a preference for a Brand “B” of soft drinks. Therefore, if a user in the first area includes “twelve pack can sodas” in a paper-based list, this item is mapped to the most popular brand in that area, which is Brand “A.” However, if a different user in the second area includes the same words “twelve pack can sodas” in a paper-based list, the list manager predicts a twelve pack can sodas of “Brand B” as the most common item which is mapped to the generic item description and added to the digital list. Thus, the same item description in different regions can result in different predicted items.

Other embodiments provide a paper-based Gen AI solution to make the order placements easier for the customers and also help in getting non-tech savvy customers onboarded. Some customers are not tech savvy and have difficulty placing orders via a website or application. The system enables users to provide a paper list of items desired by the user. The customer can select items and quantity from a predefined set of items provided in a reusable paper or a handwritten list of items and quantity of items. An image of the paper list is captured and uploaded to the Gen AI system. Optical character recognition is used to read the list. If the system is uncertain, the user is queried for feedback/confirmation of the list. The user does not have to select an item from a list of possible suggested items or pick a specific item from several choices. Instead, the system predicts one single item that is most likely to be preferred by a customer based on historical data, market trends, previous purchases, seasonal data, and other historical data. This provides a simple way for a user to create an order with minimal user involvement and/or interaction with the system.

Some embodiments utilize fuzzy matching to match items in the handwritten list/predefined list with items in inventory. The user confirms the automatically generated list via a UI. The confirmation may be provided by the customer or an associate. The system displays items for verification via a user interface. A feedback loop using user provided feedback is enabled to improve item recognition/OCR results and fuzzy matching of handwritten items with items in inventory. The system enables users to correct the system generated list and/or quantities of each item via a UI. The system links items in a handwritten list/predefined list in a paper format with items in system inventory available for sale/purchase using OCR and fuzzy matching.

Other embodiments make placement of orders via e-commerce (website/application) easier for non-tech savvy customers without having to call or wait for assistance from a human/customer support provider. To place an order using handwritten list of items, the user provides an image of a paper list. The system provides an option on the platform for the users to upload images of their handwritten lists. This can be as simple as clicking a button to upload a photo or scanning a document. The system accepts images in common image formats, such as JPEG, PNG, and/or PDF files. The system utilizes OCR and OMR to automatically recognize and convert images into digital text. Libraries like Tesseract (an open-source OCR engine) or paid services can be used to extract text data form the image(s). The system is able to analyze image data to recognize item quantity and measurements. After the OCR processes the list, the system displays the recognized items to the user for verification. This allows the user to correct any mistakes in case the OCR failed to accurately predict items in the list. In other embodiments, a representative or other staff member verifies the items in the digital list before the order is processed. Once the text is recognized, the system automatically matches the listed items with the products in the inventory.

In some embodiments, fuzzy matching algorithms can be used to handle variations in product names. For example, if the paper-based list says “tissue,” the system might translate the text as “tires.” Fuzzy matching and ML, including Gen AI, can be used to refine the translation and interpretation of the text-based data extracted from the paper-based list to more accurately identify both specific items as well as generic item descriptions from the handwritten words, printed text, as well as other marks, such as check marks, bubble fill, circles around printed item names, etc.

In other embodiments, once the digital list is finalized following user confirmation of the digital list, the system automatically adds the recognized and matched items to a digital cart. The system guides the user through the usual checkout process with guided navigation and consistent layout.

If some items are not recognized or matched, in other embodiments, the system provides an option for the user to manually enter or select these items from a list of suggestions. The system can alternatively summon assistance for the user via in-person assistance, a chatbot, instant messaging/live chat with a representative, a phone call to customer support, or other assistance options. The system can be re-trained or fine-tuned using feedback obtained from users indicating whether the predicted items added to the list were accurate/appropriate choices given the item descriptions in the paper-based list. This allows the ML model to learn and regularly update the OCR system to improve its accuracy.

Alternatively, or in addition to the other embodiments described herein, examples include any combination of the following:
receive feedback from a user associated with the predicted most common specific item via a generative artificial intelligence (Gen AI) model in response to a user rejection of the predicted most common specific item;
identify an issue associated with the user rejection of the predicted most common specific item;
create updated training data using the feedback;
retrain the ML model using the received updated training data;
identify a plurality of generic item types in the paper-based list;
predict a most common specific item for each generic item type in the plurality of generic item types;
map the predicted most common specific item to each generic item type;
add each mapped predicted most common specific item to the digital list;
wherein the generic item description lacks a quantity value indicating a number of instances of the generic item type;
analyze the historical item preferences data associated with the predicted most common item, the historical item preferences data comprising user-specific previous quantity selections data;
predict a quantity value for the predicted most common item;
update the digital list with the predicted quantity value for the predicted most common item;
predict a second most common specific item from the plurality of specific items;
map a specific item ID of the second most common specific item to the generic item type in response to receiving a user-rejection of the first predicted most common item;
add the specific item ID to the digital list;
predict a specific variety of the generic item type and a size option for the generic item type using the user-specific historical item preferences data, wherein the predicted most common item is an item of the predicted specific variety and having the size option;
present the digital list to a user for review via a user interface (UI) device;
prompt the user to confirm the predicted most common item mapped to the generic item type;
responsive to receiving confirmation, finalize addition of the predicted most common item to the digital list;
responsive to failure to receive confirmation, remove the predicted most common item from the digital list;
extracting, by a machine learning (ML) model, a generic item description associated with an item from an image of a paper-based list of items;
predicting a generic item type using the extracted generic item description;
identifying a plurality of specific item identifiers (IDs) associated with the generic item type, the plurality of specific item IDs corresponding to a plurality of specific items available within a region;
obtaining historical item preference data associated with the generic item type from a data storage device, the historical item preference data comprising region-specific item preferences within the region for the plurality of specific items;
generating, by the ML model, a predicted most common item from the plurality of specific items using the historical item preference data and availability data of each specific item in the plurality of specific items;
mapping a specific item ID of the predicted most common item to the generic item description in the paper-based list;
creating a digital list corresponding to the paper-based list in the image, the digital list comprising the mapped specific item ID;
storing the digital list in the data storage device, wherein an order is created using contents of the digital list;
receiving feedback from a user associated with the predicted most common specific item via a generative artificial intelligence (Gen AI) model in response to a user rejection of the predicted most common specific item;
identifying an issue associated with the user rejection of the predicted most common specific item;
creating updated training data using the feedback;
retraining the ML model using the received updated training data;
identifying a plurality of generic item types in the paper-based list;
predicting a most common specific item for each generic item type in the plurality of generic item types;
mapping the predicted most common specific item to each generic item type;
adding each mapped predicted most common specific item to the digital list;
analyzing the historical item preferences data associated with the predicted most common item, the historical item preferences data comprising user-specific previous quantity selections data;
predicting a quantity value for the predicted most common item;
updating the digital list with the predicted quantity value for the predicted most common item;
predicting a second most common specific item from the plurality of specific items;
mapping a specific item ID of the second most common specific item to the generic item type in response to receiving a user-rejection of the first predicted most common item;
adding the specific item ID to the digital list;
determining whether the generic item description includes an identification of a specific variety of the generic item type;
responsive to an absence of the identification of the specific variety, predicting a most common specific variety of the generic item type;
selecting the predicted most common item of the predicted specific variety;
determining whether the generic item description includes an identification of a size option for the generic item type;
responsive to an absence of the identification of the size option, generating a prediction of a most common size option for the predicted most common specific item using the historical item preferences data, wherein the predicted most common item is an item of the predicted most common size option;
extracting, by a machine learning (ML) model, a generic item description from text visible within an image of a paper-based list using optical character recognition (OCR) and optical marker recognition (OMR), wherein the text comprises at least one of printed text or handwritten markings;
surfacing a prompt to a user via a UI device to confirm the predicted most common item added to the digital list;
responsive to receiving confirmation, finalizing the digital list;
responsive to receiving a rejection of the predicted most common item, surfacing a prompt to the user to provide feedback via the UI device;
responsive to receiving the feedback, analyzing the feedback to identify an issue associated with the user rejection of the predicted most common specific item;
creating updated training data using the feedback, including the identified issue;
retraining the ML model using the received updated training data;
extracting a second generic item description from the text visible within the image of the paper-based list;
predicting a second generic item type using the extracted second generic item description;
retrieving a second plurality of specific item IDs associated with the generic item type, the plurality of specific item IDs corresponding to a second plurality of specific items available within the region;
generating a second predicted most common item from the second plurality of specific items using the historical item preference data and availability data of each specific item in the second plurality of specific items;
mapping a second specific item ID of the second predicted most common item to the second generic item description;
adding the second specific item ID to the digital list;
identifying a default quantity value for the predicted most common specific item;
updating the digital list with the default quantity value for the predicted most common item;
responsive to receiving a user rejection of the predicted most common specific item, predicting a second most common specific item;
mapping a specific item ID of the second most common specific item to the generic item type;
adding the specific item ID to the digital list;
presenting the digital list to a user for review via a user interface (UI) device;
prompting the user to confirm the predicted most common item mapped to the generic item type;
responsive to receiving confirmation, finalizing addition of the predicted most common item to the digital list; and
responsive to failure to receive confirmation, removing the predicted most common item from the digital list.

At least a portion of the functionality of the various elements in FIG. 1 and FIG. 2 can be performed by other elements in FIG. 1 and FIG. 2, or an entity (e.g., processor 106, web service, server, application program, computing device, etc.) not shown in FIG. 1 and FIG. 2.

In some embodiments, the operations illustrated in FIG. 4, FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other embodiments, a computer readable medium having instructions recorded thereon which when executed by a computer device cause the computer device to cooperate in performing a method of creation of accurate digital lists from paper-based sources, the method comprising extracting, by a machine learning (ML) model, a generic item description associated with an item from an image of a paper-based list of items; predicting a generic item type using the extracted generic item description; identifying a plurality of specific item identifiers (IDs) associated with the generic item type, the plurality of specific item IDs corresponding to a plurality of specific items available within a region; obtaining historical item preference data associated with the generic item type from a data storage device, the historical item preference data comprising region-specific item preferences within the region for the plurality of specific items; generating, by the ML model, a predicted most common item from the plurality of specific items using the historical item preference data and availability data of each specific item in the plurality of specific items; mapping a specific item ID of the predicted most common item to the generic item description in the paper-based list; creating a digital list corresponding to the paper-based list in the image, the digital list comprising the mapped specific item ID; and storing the digital list in the data storage device, wherein an order is created using contents of the digital list.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some embodiments, to a wireless local area network using high frequency radio signals for the transmission of data. The term “BLUETOOTH®” as used herein refers, in some embodiments, to a wireless technology standard for exchanging data over short distances using short wavelength radio transmission. The term “NFC” as used herein refers, in some embodiments, to a short-range high frequency wireless communication technology for the exchange of data over short distances.

While no personally identifiable information is tracked by aspects of the disclosure, examples have been described with reference to data monitored and/or collected from the users. In some embodiments, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other embodiments of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for converting paper-based lists into digital lists of items for online order creation. For example, the elements illustrated in FIG. 1 and FIG. 2, such as when encoded to perform the operations illustrated in FIG. 4, FIG. 5, FIG. 6, and FIG. 7, constitute exemplary means for extracting, by a machine learning (ML) model, a generic item description associated with an item from an image of a paper-based list of items; exemplary means for predicting a generic item type using the extracted generic item description; exemplary means for identifying a plurality of specific item identifiers (IDs) associated with the generic item type, the plurality of specific item IDs corresponding to a plurality of specific items available within a region; exemplary means for obtaining historical item preference data associated with the generic item type from a data storage device, the historical item preference data comprising region-specific item preferences within the region for the plurality of specific items; exemplary means for generating, by the ML model, a predicted most common item from the plurality of specific items using the historical item preference data and availability data of each specific item in the plurality of specific items; exemplary means for mapping a specific item ID of the predicted most common item to the generic item description in the paper-based list; exemplary means for creating a digital list corresponding to the paper-based list in the image, the digital list comprising the mapped specific item ID; and exemplary means for storing the digital list in the data storage device, wherein an order is created using contents of the digital list.

Other non-limiting examples provide one or more computer storage devices having a first computer-executable instructions stored thereon for providing creation of accurate digital lists from paper-based sources. When executed by a computer, the computer performs operations including extracting, by a machine learning (ML) model, a generic item description from text visible within an image of a paper-based list using optical character recognition (OCR) and optical marker recognition (OMR), wherein the text comprises at least one of printed text or handwritten markings; predicting a generic item type using the extracted generic item description; identifying a plurality of specific item identifiers (IDs) associated with the generic item type, the plurality of specific item IDs corresponding to a plurality of specific items available within a region; obtaining historical item preference data associated with the generic item type, the historical item preference data comprising region-specific item preferences within the region for the plurality of specific items; generating, by the ML model, a predicted most common item from the plurality of specific items using the historical item preference data and availability data of each specific item in the plurality of specific items; mapping a specific item ID of the predicted most common item to the generic item description in the paper-based list; creating a digital list corresponding to the paper-based list in the image, the digital list comprising the mapped specific item ID; and storing the digital list in a data storage device, wherein the digital list is used to create an order.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for creation of accurate digital lists from paper-based sources, the system comprising:
an image capture device for generating an image of a paper-based list comprising a generic item description for an item, the generic item description lacking at least one of a specific item name and a size option of the item;
a computer-readable medium storing instructions that are operative upon execution by a processor to:
extract, by a machine learning (ML) model, the generic item description from the image of the paper-based list;
predict a generic item type using the extracted generic item description;
identify a plurality of specific item identifiers (IDs) associated with the generic item type, the plurality of specific item IDs corresponding to a plurality of specific items available within a region;
obtain historical item preference data associated with the generic item type from a data storage device, the historical item preference data comprising region-specific item preferences within the region for the plurality of specific items;
generate, by the ML model, a predicted most common item from the plurality of specific items using the historical item preference data and availability data of each specific item in the plurality of specific items;
map a specific item ID of the predicted most common item to the generic item description in the paper-based list; and
create a digital list corresponding to the paper-based list in the image, the digital list comprising the mapped specific item ID, wherein an order is created using contents of the digital list.

2. The system of claim 1, wherein the instructions are further operative to:
receive feedback from a user associated with the predicted most common specific item via a generative artificial intelligence (Gen AI) model in response to a user rejection of the predicted most common specific item;
identify an issue associated with the user rejection of the predicted most common specific item;
create updated training data using the feedback; and
retrain the ML model using the received updated training data.

3. The system of claim 1, wherein the instructions are further operative to:
identify a plurality of generic item types in the paper-based list;
predict a most common specific item for each generic item type in the plurality of generic item types; and
map the predicted most common specific item to each generic item type; and
add each mapped predicted most common specific item to the digital list.

4. The system of claim 1, wherein the generic item description lacks a quantity value indicating a number of instances of the generic item type, and wherein the instructions are further operative to:
analyze the historical item preferences data associated with the predicted most common item, the historical item preferences data comprising user-specific previous quantity selections data;
predict a quantity value for the predicted most common item; and
update the digital list with the predicted quantity value for the predicted most common item.

5. The system of claim 1, wherein the predicted most common specific item is a first predicted most common item, and wherein the instructions are further operative to:
predict a second most common specific item from the plurality of specific items;
map a specific item ID of the second most common specific item to the generic item type in response to receiving a user-rejection of the first predicted most common item; and
add the specific item ID to the digital list.

6. The system of claim 1, wherein the historical item preferences data comprises user-specific historical item preferences data associated with a user ID associated with the paper-based list, and wherein the instructions are further operative to:
predict a specific variety of the generic item type and a size option for the generic item type using the user-specific historical item preferences data, wherein the predicted most common item is an item of the predicted specific variety and having the size option.

7. The system of claim 1, wherein the instructions are further operative to:
present the digital list to a user for review via a user interface (UI) device;
prompt the user to confirm the predicted most common item mapped to the generic item type;
responsive to receiving confirmation, finalize addition of the predicted most common item to the digital list; and
responsive to failure to receive confirmation, remove the predicted most common item from the digital list.

8. A method for creation of accurate digital lists from paper-based sources, the method comprising:
extracting, by a machine learning (ML) model, a generic item description associated with an item from an image of a paper-based list of items;
predicting a generic item type using the extracted generic item description;
identifying a plurality of specific item identifiers (IDs) associated with the generic item type, the plurality of specific item IDs corresponding to a plurality of specific items available within a region;
obtaining historical item preference data associated with the generic item type from a data storage device, the historical item preference data comprising region-specific item preferences within the region for the plurality of specific items;
generating, by the ML model, a predicted most common item from the plurality of specific items using the historical item preference data and availability data of each specific item in the plurality of specific items;
mapping a specific item ID of the predicted most common item to the generic item description in the paper-based list;
creating a digital list corresponding to the paper-based list in the image, the digital list comprising the mapped specific item ID; and
storing the digital list in the data storage device, wherein an order is created using contents of the digital list.

9. The method of claim 8, further comprising:
receiving feedback from a user associated with the predicted most common specific item via a generative artificial intelligence (Gen AI) model in response to a user rejection of the predicted most common specific item;
identifying an issue associated with the user rejection of the predicted most common specific item;
creating updated training data using the feedback; and
retraining the ML model using the received updated training data.

10. The method of claim 8, further comprising:
identifying a plurality of generic item types in the paper-based list;
predicting a most common specific item for each generic item type in the plurality of generic item types; and
mapping the predicted most common specific item to each generic item type; and
adding each mapped predicted most common specific item to the digital list.

11. The method of claim 8, wherein the generic item description lacks a quantity value indicating a number of instances of the generic item type, and further comprising:
analyzing the historical item preferences data associated with the predicted most common item, the historical item preferences data comprising user-specific previous quantity selections data;
predicting a quantity value for the predicted most common item; and
updating the digital list with the predicted quantity value for the predicted most common item.

12. The method of claim 8, wherein the predicted most common specific item is a first predicted most common item, and further comprising:
predicting a second most common specific item from the plurality of specific items;
mapping a specific item ID of the second most common specific item to the generic item type in response to receiving a user-rejection of the first predicted most common item; and
adding the specific item ID to the digital list.

13. The method of claim 8, further comprising:
determining whether the generic item description includes an identification of a specific variety of the generic item type;
responsive to an absence of the identification of the specific variety, predicting a most common specific variety of the generic item type; and
selecting the predicted most common item of the predicted specific variety.

14. The method of claim 8, further comprising:
determining whether the generic item description includes an identification of a size option for the generic item type;
responsive to an absence of the identification of the size option,
generating a prediction of a most common size option for the predicted most common specific item using the historical item preferences data, wherein the predicted most common item is an item of the predicted most common size option.

15. One or more computer storage devices having computer-executable instructions stored thereon, which, upon execution by a computer, cause the computer to perform operations comprising:
extracting, by a machine learning (ML) model, a generic item description from text visible within an image of a paper-based list using optical character recognition (OCR) and optical marker recognition (OMR), wherein the text comprises at least one of printed text or handwritten markings;
predicting a generic item type using the extracted generic item description;
identifying a plurality of specific item identifiers (IDs) associated with the generic item type, the plurality of specific item IDs corresponding to a plurality of specific items available within a region;
obtaining historical item preference data associated with the generic item type, the historical item preference data comprising region-specific item preferences within the region for the plurality of specific items;
generating, by the ML model, a predicted most common item from the plurality of specific items using the historical item preference data and availability data of each specific item in the plurality of specific items;
mapping a specific item ID of the predicted most common item to the generic item description in the paper-based list;
creating a digital list corresponding to the paper-based list in the image, the digital list comprising the mapped specific item ID; and
storing the digital list in a data storage device, wherein the digital list is used to create an order.

16. The one or more computer storage devices of claim 15, wherein the operations further comprise:
surfacing a prompt to a user via a UI device to confirm the predicted most common item added to the digital list;
responsive to receiving confirmation, finalizing the digital list;
responsive to receiving a rejection of the predicted most common item, surfacing a prompt to the user to provide feedback via the UI device;
responsive to receiving the feedback, analyzing the feedback to identify an issue associated with the user rejection of the predicted most common specific item;
creating updated training data using the feedback, including the identified issue; and
retraining the ML model using the received updated training data.

17. The one or more computer storage devices of claim 15, wherein the operations further comprise:
extracting a second generic item description from the text visible within the image of the paper-based list;
predicting a second generic item type using the extracted second generic item description;
retrieving a second plurality of specific item IDs associated with the generic item type, the plurality of specific item IDs corresponding to a second plurality of specific items available within the region;
generating a second predicted most common item from the second plurality of specific items using the historical item preference data and availability data of each specific item in the second plurality of specific items;
mapping a second specific item ID of the second predicted most common item to the second generic item description;
adding the second specific item ID to the digital list.

18. The one or more computer storage devices of claim 15, wherein the generic item description lacks a quantity value indicating a number of instances of the generic item type, and wherein the operations further comprise:
identifying a default quantity value for the predicted most common specific item; and
updating the digital list with the default quantity value for the predicted most common item.

19. The one or more computer storage devices of claim 15, wherein the operations further comprise:
responsive to receiving a user rejection of the predicted most common specific item, predicting a second most common specific item;
mapping a specific item ID of the second most common specific item to the generic item type; and
adding the specific item ID to the digital list.

20. The one or more computer storage devices of claim 15, wherein the operations further comprise:
presenting the digital list to a user for review via a user interface (UI) device;
prompting the user to confirm the predicted most common item mapped to the generic item type;
responsive to receiving confirmation, finalizing addition of the predicted most common item to the digital list; and
responsive to failure to receive confirmation, removing the predicted most common item from the digital list.
